(19) United States
(12) Patent Application Publication
(10) Pub. No.: US 2024/0152979 A1
(43) Pub. Date: May 9, 2024

(54) ELECTRONIC CURRENCY SYSTEM, ELECTRONIC CURRENCY VALUE DETERMINATION APPARATUS, METHOD, AND COMPUTER-READABLE MEDIUM

(71) Applicant: NEC Corporation, Minato-ku, Tokyo (JP)

(72) Inventors: Yuki Tsuji, Tokyo (JP); Shintaro Chiku, Tokyo (JP); Naoko Fukushi, Tokyo (JP); Yoko Tanaka, Tokyo (JP); Kazuki Ogata, Tokyo (JP); Kosei Kobayshi, Tokyo (JP); Kei Yanagisawa, Tokyo (JP)

(73) Assignee: NEC Corporation, Minato-ku, Tokyo (JP)

(21) Appl. No.: 18/278,700

(22) PCT Filed: Mar. 31, 2021
(86) PCT No.: PCT/JP2021/013808

§ 371 Date: Aug. 24, 2023

(51) Int. Cl. G06Q 30/0283; G06Q 20/06; G06Q 20/38

(52) U.S. Cl. CPC G06Q 30/0283; G06Q 20/0652; G06Q 20/381

(57) ABSTRACT

A congestion degree measurement unit measures a congestion degree in each of a plurality of areas in which the electronic currency issued to the user can be used. A value determination unit determines a utility value of the electronic currency in the area, based on the congestion degree measured by the congestion degree measurement unit.

### TECHNICAL FIELD

The present disclosure relates to an electronic currency system, an electronic currency value determination apparatus, a method, and a computer-readable medium.

### BACKGROUND ART

An electronic currency system capable of electronic payment is known. In an electronic currency system, an electronic currency is given as a point that can be converted into, for example, a monetary value. There is also an initiative to limit an area where an electronic currency can be used and to use the electronic currency (local currency) that can be used in the area for regional revitalization.

As a related art, Patent Literature 1 discloses an electronic money server. The electronic money server transfers electronic money (value) from a transfer source account to a transfer destination account. When the electronic money server transfers the electronic value, the electronic money server associates an electronic ticket to which an application condition is designated by a third party, with a transfer destination user. The electronic ticket is an electronic gift, and the application condition includes an area in which the electronic gift can be used, a period in which the electronic gift can be used, and a time zone in which the electronic gift can be used. When the user of the transfer destination account uses the electronic value and the application condition is satisfied, the electronic money server executes processing for causing the third party to bear at least a part of a used amount.

### CITATION LIST

### Patent Literature

Patent Literature 1: International Patent Publication No. WO2014/103046

### SUMMARY OF INVENTION

### Technical Problem

In Patent Literature 1, a user of a money transfer destination can use an electronic gift (value) within a range of an application condition designated by a third party. For example, in a case of a restaurant, a condition that the electronic gift can be used only during a time zone other than lunch hours is set as an application condition. In this case, a user who wants to use an electronic gift visits the restaurant while avoiding congested lunch hours. Therefore, the electronic gift to which such an application condition is set can contribute to efficient management of the restaurant.

However, in Patent Literature 1, an actual congestion condition of a store is not considered. In Patent Literature 1, during a time zone in which an electronic gift can be used being designated as an application condition, even when a store is actually congested, a user may use the electronic gift, and a congested condition may not be alleviated.

In view of the above-described circumstance, an object of the present disclosure is to provide an electronic currency system, an electronic currency value determination apparatus, a method, and a computer-readable medium that enable alleviation of a congestion condition.

### Solution to Problem

In order to achieve the above-described object, the present disclosure provides, as a first aspect, an electronic currency value determination apparatus. The electronic currency value determination apparatus includes: a congestion degree measurement means for measuring a congestion degree in each of a plurality of areas in which an electronic currency issued to a user can be used; and a value determination means for determining a utility value of the electronic currency in the area, based on the congestion degree measured by the congestion degree measurement means.

The present disclosure provides, as a second aspect, an electronic currency system. The electronic currency system includes an electronic currency value determination apparatus and a payment server. The electronic currency value determination apparatus includes: a congestion degree measurement means for measuring a congestion degree in each of a plurality of areas in which an electronic currency issued to a user can be used; and a value determination means for determining a utility value of the electronic currency in the area, based on the congestion degree measured by the congestion degree measurement means. The payment server allows the user to use the electronic currency at the utility value determined by the electronic currency value determination apparatus.

The present disclosure provides, as a third aspect, an electronic currency value determination method. The electronic currency value determination method includes: measuring a congestion degree in each of a plurality of areas in which an electronic currency issued to a user can be used; and determining a utility value of the electronic currency in the area, based on the measured congestion degree.

The present disclosure provides, as a fourth aspect, a computer-readable medium. The computer-readable medium stores a program for causing a computer to execute processing of: measuring a congestion degree in each of a plurality of areas in which an electronic currency issued to a user can be used; and determining a utility value of the electronic currency in the area, based on the measured congestion degree.

### Advantageous Effects of Invention

The electronic currency system, the electronic currency value determination apparatus, the method, and the computer-readable medium according to the present disclosure enable a user to use electronic currency while avoiding congestion.

### BRIEF DESCRIPTION OF DRAWINGS

FIG. 1 is a block diagram illustrating an electronic currency system according to a first example embodiment of the present disclosure;

FIG. 2 is a diagram illustrating an area in which an electronic currency can be used;

FIG. 3 is a flowchart illustrating an operation procedure of an electronic currency value determination apparatus;

FIG. 4 is a block diagram illustrating an electronic currency value determination apparatus used in an electronic currency system according to a second example embodiment of the present disclosure;

FIG. 5 is a diagram illustrating a specific example of a characteristic information stored in a characteristic information storage unit; and

FIG. 6 is a block diagram illustrating a configuration example of a computer apparatus.

### EXAMPLE EMBODIMENT

Hereinafter, example embodiments of the present disclosure will be described in detail. FIG. 1 illustrates an electronic currency system according to a first example embodiment of the present disclosure. An electronic currency system 100 includes an electronic currency value determination apparatus 110 and a payment server 120. The electronic currency value determination apparatus 110 includes a congestion degree measurement unit (congestion degree measurement means) 111 and a value determination unit (value determination means) 112. The electronic currency value determination apparatus 110 is configured as, for example, a computer apparatus (server apparatus) having a processor and a memory. At least a part of a function of each unit of the electronic currency value determination apparatus 110 may be implemented by the processor operating in accordance with a program read from the memory.

In the present example embodiment, an electronic currency is issued to a user. The electronic currency may be a local currency available in a predetermined region. The electronic currency is issued, for example, as a point that can be converted into a monetary value.

The congestion degree measurement unit 111 measures a congestion degree in each of a plurality of areas (sub-areas) included in the predetermined region. The congestion degree measurement unit 111 may measure the congestion degree of each area by aggregating a signal such as a beacon transmitted from a terminal device possessed by a user in each of the plurality of areas. Alternatively, the congestion degree measurement unit 111 may perform video analysis on a video captured by a camera installed in each area and measure the congestion degree of each area. A method of measuring the congestion degree may be in any form and is not particularly limited. For example, the congestion degree measurement unit 111 periodically measures the congestion degree, and periodically updates the congestion degree of each area.

The value determination unit 112 determines a utility value of the electronic currency in each area, based on the congestion degree measured by the congestion degree measurement unit 111. The value determination unit 112 determines, for example, a money conversion rate per unit point of the electronic currency issued as a point, as the utility value of the electronic currency. For example, the value determination unit 112 classifies the congestion degrees of the plurality of areas into a plurality of levels. For example, the value determination unit 112 classifies the congestion degrees of the plurality of areas into three levels: a congestion degree [high], a congestion degree [medium], and a congestion degree [low]. The value determination unit 112 may determine the utility value of the electronic currency according to the classified congestion level.

The value determination unit 112 determines, for example, whether the congestion degree is higher than a first threshold value. When a congestion degree of an area is higher than the first threshold value, the value determination unit 112 classifies the congestion degree of the area as [high]. For example, the value determination unit 112 determines whether the congestion degree is lower than a second threshold value. The second threshold value indicates a congestion degree lower than the first threshold value. When the congestion degree of the area is lower than the second threshold value, the value determination unit 112 classifies the congestion degree of the area as [low]. When the congestion degree of the area is equal to or less than the first threshold value and the congestion degree is equal to or greater than the second threshold value, the value determination unit 112 classifies the congestion degree of the area as [medium].

When the electronic currency is used in an area where the congestion degree is high, the value determination unit 112 may decrease a monetary value per point to be lower than a monetary value per point in a case in which the electronic currency is used in an area that is not congested. The value determination unit 112 decreases a money conversion rate of the electronic currency in the area where the congestion degree is classified as [high] to be lower than a money conversion rate in an area where the congestion degree is classified as [medium]. In this case, in the congested area, the utility value of the electronic currency is lower than the utility value in the non-congested area.

Decreasing the utility value of the electronic currency includes disabling use of electronic currency. When the congestion degree is classified as [high], the value determination unit 112 may set the money conversion rate of the electronic currency in the area to zero. In this case, the user cannot use the electronic currency in the congested area. As a result, the user can be expected to move from the area with a high congestion degree to an area with a low congestion degree and use the electronic currency.

Conversely, when the electronic currency is used in an area where the congestion degree is low, the value determination unit 112 may increase the monetary value per point to be higher than the money conversion rate in a case in which the electronic currency is used in an area where the congestion degree is moderate. The value determination unit 112 increases the money conversion rate of the electronic currency in an area where the congestion degree is classified as [low] to be higher than the money conversion rate in an area where the congestion degree is classified as [medium]. In this case, in an area where the number of persons is small, the utility value of the electronic currency is increased to be higher than the utility value in the area where the congestion degree is classified as [medium]. As a result, the user can be expected to move to the area with a low congestion degree and use the electronic currency.

The payment server 120 allows the user to use the electronic currency at the utility value determined by the electronic currency value determination apparatus 110. The settlement server 120 allows the user to use the electronic currency at the utility value of the electronic currency determined for each area according to the congestion degree. The payment server 120, for example, manages points of the electronic currency of each user and, in conjunction with a point of sale system (POS) terminal installed in a store, allows the user to use the electronic currency at the determined utility value of the electronic currency.

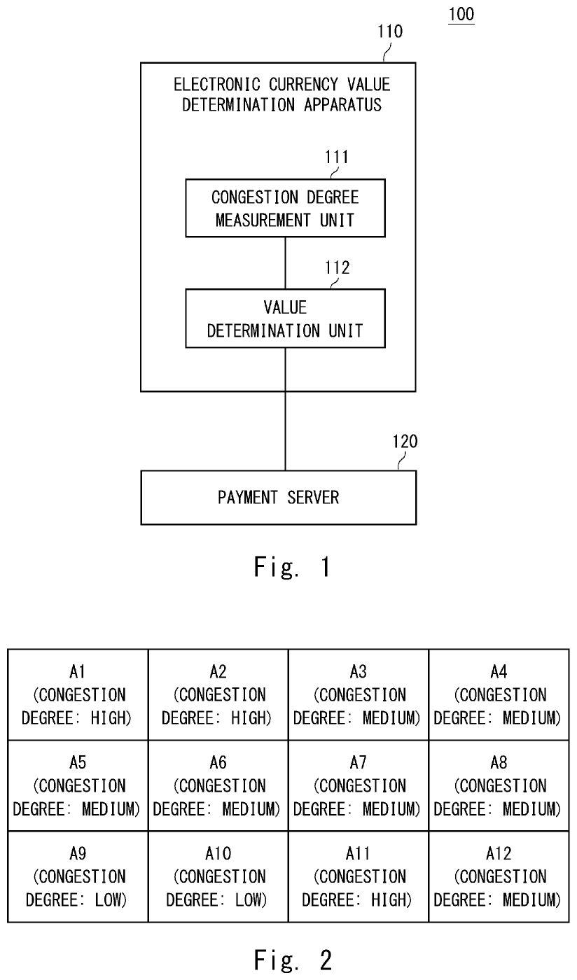

FIG. 2 illustrates a region where the electronic currency can be used. Here, a region including areas A1 to A12 is considered as a region in which the user can use the electronic currency. The congestion degree measurement unit 111 measures the congestion degree for each of the areas A1 to A12. In FIG. 2, it is assumed that the areas A1, A2, and A11 are areas of which congestion degrees are classified as [high]. Further, it is assumed that the areas A9 and 10 are areas of which congestion degrees are classified as [low]. It is assumed that the areas A3 to A8 and A12 are areas of which congestion degrees are classified as [medium].

The value determination unit 112 decreases the utility value of the electronic currency in the areas A1, A2, and A11 of which congestion degrees are classified as [high] to be lower than a normal utility value. The value determination unit 112 does not change the utility value of the electronic currency from the normal utility value in areas A3 to A8, A11, and A12 of which congestion degrees are classified as [medium]. The value determination unit 112 increases the utility value of the electronic currency in the areas A91 and A10 of which congestion degrees are classified as [low] to be higher than the normal utility value. The value determination unit 112 may transmit the determined utility value of the electronic currency in each of the areas to the terminal device possessed by the user. Alternatively, the value determination unit 112 may disclose the determined utility value of the electronic currency in each of the areas on a web page and the like.

For example, in the area A1, a user in the area A1 can only use the electronic currency at a utility value lower than the normal utility value, or cannot use the electronic currency. In this case, the user voluntarily moves from the area A1 to another area, for example, the area A5, in which the electronic currency can be used at the normal utility value. The user can use the electronic currency at the normal utility value in the destination area A5. When the user moves to the area A9 of which congestion degree is classified as [low], the user can use the electronic currency at a utility value higher than the normal utility value. When the congestion degree of the area A1 decreases and the congestion degree of the area A1 becomes [medium], in the area A1, the user can use the electronic currency at the usual use value.

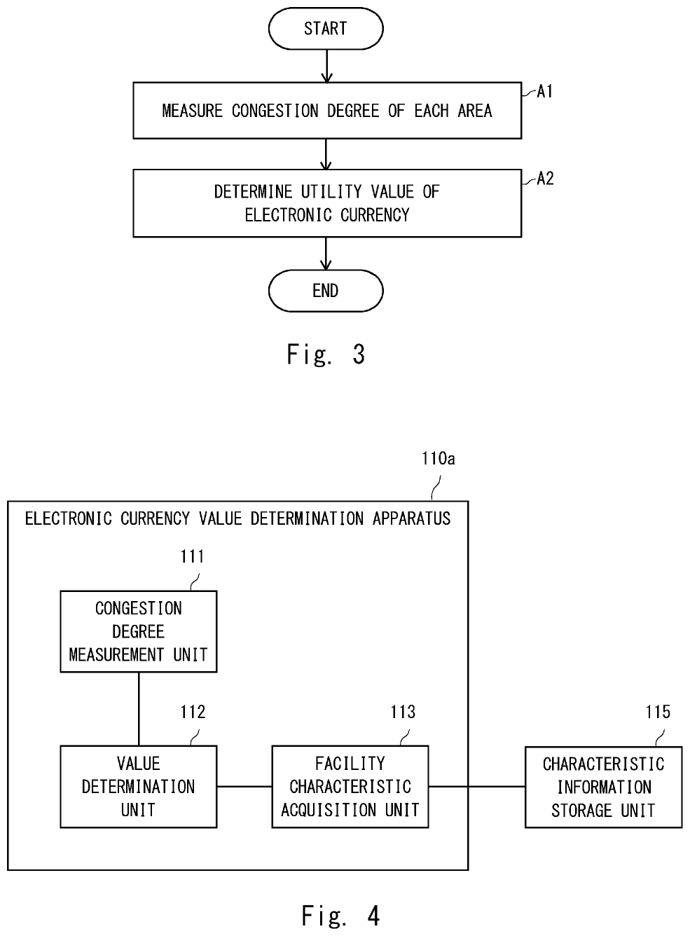

Next, an operation procedure will be described. FIG. 3 illustrates an operation procedure (electronic currency value determination method) in the electronic currency value determination apparatus 110. The congestion degree measurement unit 111 measures a congestion degree in each area (step A1). For each area, the congestion degree measurement unit 111 measures, for example, the number of persons per unit area as an index indicating the congestion degree. The value determination unit 112 determines a utility value of the electronic currency in each area, based on the measured congestion degree (step A2). For example, the value determination unit 112 decreases the utility value of the electronic currency in a congested area to be lower than the utility value of the electronic currency in a non-congested area.

In the present example embodiment, the value determination unit 112 determines the utility value of an electronic currency value according to the congestion degree measured by the congestion degree measurement unit 111. In other words, the electronic currency value determination apparatus 110 determines the utility value of the electronic currency in each area in such a way as to be dependent upon the congestion degree of each area. In this way, in the present example embodiment, the user can be guided from an area where the utility value of the electronic currency is low to an area where the utility value of the electronic currency is not low. Therefore, the present example embodiment enables the user to use electronic currency while avoiding congestion.

Next, a second example embodiment of the present disclosure will be described. FIG. 4 illustrates an electronic currency value determination apparatus used in an electronic currency system according to a second example embodiment of the present disclosure. In the present example embodiment, an electronic currency value determination apparatus 110a includes a facility characteristic acquisition unit 113 in addition to the components of the electronic currency value determination apparatus 110 according to the first example embodiment illustrated in FIG. 1.

The facility characteristic acquisition unit 113 acquires, from a characteristic information storage unit 115, characteristic information of a facility existing in each area. In the present example embodiment, a store existing in each area will be described as an example of a facility. The characteristic information storage unit 115 stores characteristic information of each store. The characteristic information includes, for example, at least one of information indicating whether the store is located outdoor, information indicating whether the store is a store where food and beverage are served, and information indicating whether the store is a place where customers have conversations with each other. The characteristic information may include information indicating whether the store is a store in which a measure against infectious disease is taken. The characteristic information may include information indicating a degree of the measure taken against infectious disease in the store. The characteristic information may include information indicating a type of business. The characteristic information may include information indicating whether the store is a specific store certified by a local government or a specific organization in a region in which an electronic currency is used.

In the present example embodiment, the value determination unit 112 determines a utility value of the electronic currency by using the characteristic information acquired by the facility characteristic acquisition unit 113 in addition to a congestion degree measured by a congestion degree measurement unit 111. For example, the value determination unit 112 may change, for each of a plurality of stores in an area, a first threshold value used in classification of the congestion degree, according to a characteristic of the store existing in the area. For example, the value determination unit 112 may determine the first threshold value for each store, based on at least one of whether the store is located outdoor, whether the store is a store where food and beverage are served, and whether the store is a place where customers have conversations with each other. The value determination unit 112 may determine the first threshold value according to whether the store is a store in which a measure against infectious disease is taken and/or a degree of the measure taken against infectious disease in the store.

In the above-described case, by changing the first threshold value, it is possible that for the same congestion degree, a store having a certain characteristic is classified as having a [high] congestion degree while a store having another characteristic is classified as having a [medium] congestion degree. By changing, according to a characteristic of a store, the first threshold value used as a criterion for classifying a congestion degree as [high], the value determination unit 112 can change the utility value of the electronic currency in an area of a certain congestion degree according to the characteristics of the store. When the store is a specific store certified by a local government or the like, the value determination unit 112 may not decrease the utility value of the electronic currency even when the congestion degree is high. The value determination unit 112 may change, according to the characteristic of the store a second threshold value used as a criterion for classifying a congestion degree as [low].

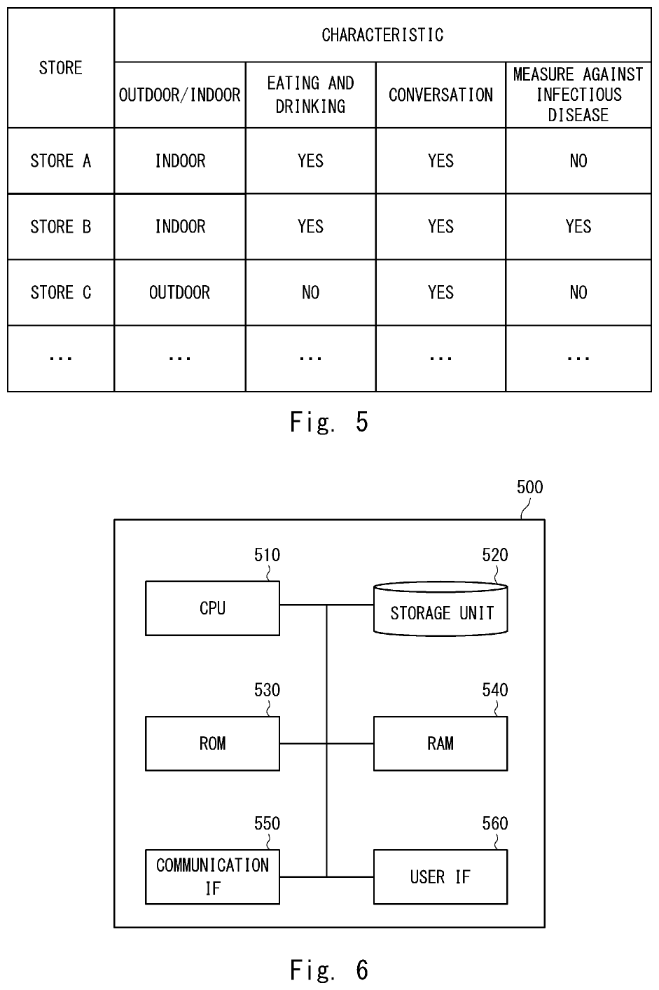

FIG. 5 illustrates a specific example of the characteristic information stored in the characteristic information storage unit 115. In this example, the characteristic information includes, for each store, an outdoor/indoor type, whether food and beverage are served, whether customers have conversations with each other, whether a measure against infectious disease is taken, and whether the store is certified as a specific store. The value determination unit 112 may determine the first threshold value according to a combination of items in the characteristic information.

For example, the value determination unit 112 determines the first threshold value to be a relatively low value for a store where congestion is allowed to some extent from a characteristic of the store. For example, the value determination unit 112 determines the first threshold value to be a relatively low value for a store located indoor, a store where food and beverage are served, a store where customers have conversations with each other, and a store where no measure against infectious disease is taken. Meanwhile, the value determination unit 112 determines the first threshold value to be a relatively large value for a store located outdoor, a store where no food or beverage is served, a store where customers do not have conversations with each other, and a store where a measure against infectious diseases is taken.

For example, in the example in FIG. 5, a store A and a store B have a characteristic that being located indoor, food and beverage are served, and customers have conversations with each other. Further, the store A has a characteristic that no measure against infectious disease is taken, and the store B has a characteristic that a measure against infectious disease is taken. In this case, the value determination unit 112 determines the first threshold value for classifying a congestion degree of the store A to be lower than the first threshold value for classifying a congestion degree of the store B. In this case, even when the congestion degree of the store A and the congestion degree of the store B are the same, the congestion degree of the store A may be classified as [high], and the congestion degree of the store B may be classified as [medium]. In this case, the value determination unit 112 may decrease a utility value of the electronic currency for the store A, and may set a utility value of the electronic currency for the store B as a normal utility value.

In the present example embodiment, the value determination unit 112 determines the utility value of the electronic currency value by using the characteristic information acquired by the facility characteristic acquisition unit 113. In the present example embodiment, the utility value of the electronic currency can be determined in consideration of not only the congestion degree but also the characteristic of the store. For example, the value determination unit 112 changes the first threshold value according to the characteristic of the store, thereby classifying, in a certain area, a congestion degree of a store located outdoor store as [medium] and classifying a congestion degree of a store located as [high]. In this case, in the area, the utility value of the electronic currency of the store located indoor is decreased. In the present example embodiment, by changing the utility value of the electronic currency according to a characteristic of a store, the user can be guided to, for example, a store located outdoor or a store in which a measure against infectious disease is taken.

In each of the above-described example embodiments, an example has been described in which the value determination unit 112 determines the utility value of the electronic currency according to the congestion degree and the characteristic information. In each of the above-described example embodiments, the value determination unit 112 may determine the utility value of the electronic currency according to an attribute of a person who uses the electronic currency. For example, the attributes of the person include a resident living in an area where the electronic currency can be used, a tourist, gender, and an age group. For example, the value determination unit 112 may not decrease the utility value for a resident living in the area even when the congestion degree is high, and may decrease the utility value for tourists. Alternatively, the value determination unit 112 may not decrease the utility value for a person (elderly person) who belongs to a high age group even when the congestion degree is high, and may decrease the utility value for a young person.

In each of the above-described example embodiments, the example in which a facility in which the electronic currency can be used is a store has been described, but the present disclosure is not limited thereto. The present disclosure is applicable not only to a store but also to other facilities where the electronic currency can be used. For example, the present disclosure may be applied to use of facilities such as a park, an art gallery, and a museum where that the electronic currency can be used for admission. Alternatively, the present disclosure can be applied to a facility such as a movie theater or a sports gym in which the electronic currency can be used. Even in this case, the value determination unit 112 may determine a threshold value (the first threshold value and/or the second threshold value) to be used when classifying a congestion degree according to a characteristic of the facility.

In the present disclosure, the electronic currency value determination apparatus 110 may be configured as a computer apparatus (server apparatus). FIG. 6 illustrates a configuration example of a computer apparatus that can be used as the electronic currency value determination apparatus 110. The computer apparatus 500 includes a control unit (Central Processing Unit: CPU) 510, a storage unit 520, a read only memory (ROM) 530, a random access memory (RAM) 540, a communication interface (interface: IF) 550, and a user interface 560.

The communication interface 550 is an interface for connecting the computer apparatus 500 and a communication network via a wired communication means, a wireless communication means, or the like. The user interface 560 includes a display unit such as a display. The user interface 560 includes an input unit such as a keyboard, a mouse, and a touch panel.

The storage unit 520 is an auxiliary storage device capable of holding various types of data. The storage unit 520 is not necessarily a part of the computer apparatus 500, and may be an external storage device or a cloud storage connected to the computer apparatus 500 via a network.

The ROM 530 is a nonvolatile storage device. For example, a semiconductor storage device such as a flash memory having a relatively small storage capacity is used as the ROM 530. The program executed by the CPU 510 may be stored in the storage unit 520 or the ROM 530. The storage unit 520 or the ROM 530 stores various programs for achieving a function of each unit in the electronic currency value determination apparatus 110.

The program may be stored using various types of non-transitory computer-readable medium and may be provided to the computer apparatus 500. The non-transitory computer-readable medium includes various types of tangible storage medium. Examples of the non-transitory computer-readable medium include a magnetic recording medium, a magneto-optical recording medium, an optical disk medium, and a semiconductor memory. The magnetic recording medium includes a recording medium such as a flexible disk, a magnetic tape, or a hard disk. The magneto-optical recording medium includes, for example, a recording medium such as a magneto-optical disk. The optical disk media include disk media such as a compact disk (CD) or a digital versatile disk (DVD). The semiconductor memory includes a memory such as a mask ROM, a programmable ROM (PROM), an erasable PROM (EPROM), a flash ROM, or a RAM. The program may also be provided to a computer by using various types of transitory computer-readable medium. Examples of the transitory computer-readable medium include an electrical signal, an optical signal, and an electromagnetic wave. The transitory computer readable medium can supply the program to the computer via a wired communication path such as an electric wire and an optical fiber, or a wireless communication path.

The RAM 540 is a volatile storage device. Various types of semiconductor memory device such as a dynamic random access memory (DRAM) and static random access memory (SRAM) are used as the RAM 540. The RAM 540 may be used as an internal buffer for temporarily storing data and the like. The CPU 510 loads the program stored in the storage unit 520 or the ROM 530 into the RAM 540 and executes the program. By the CPU 510 executing the program, the function of each unit in the electronic currency value determination apparatus 110 can be achieved. The CPU 510 may have an internal buffer capable of temporarily storing data and the like.

While the example embodiments of the present disclosure have been described in detail above, the present disclosure is not limited to the above-described example embodiments, and changes and modifications to the above-described example embodiments without departing from the spirit of the present disclosure are also included in the present disclosure.

For example, some or all of the above-described example embodiments may be described as the following supplementary notes, but are not limited thereto.

### [Supplementary Note 1]

An electronic currency value determination apparatus comprising:
congestion degree measurement means for measuring a congestion degree in each of a plurality of areas in which an electronic currency issued to a user can be used; and
value determination means for determining a utility value of the electronic currency in the area, based on a congestion degree measured by the congestion degree measurement means.

### [Supplementary Note 2]

The electronic currency value determination apparatus according to supplementary note 1, wherein
the electronic currency is issued as a point that can be converted into money, and
the value determination means determines a money conversion rate per unit point as a utility value of the electronic currency.

### [Supplementary Note 3]

The electronic currency value determination apparatus according to supplementary note 2, wherein, when the congestion degree is higher than a first threshold value, the value determination means decreases the money conversion rate to be lower than a money conversion rate in a case in which the congestion degree is lower than the first threshold value.

### [Supplementary Note 4]

The electronic currency value determination apparatus according to supplementary note 3, wherein the value determination means determines the money conversion rate to be zero when the congestion degree is higher than the first threshold value.

### [Supplementary Note 5]

The electronic currency value determination apparatus according to supplementary note 3 or 4, wherein the value determination means changes the first threshold value for each of a plurality of facilities in the area, according to a characteristic of a facility existing in the area.

### [Supplementary Note 6]

The electronic currency value determination apparatus according to any one of supplementary notes 3 to 5, wherein the value determination means changes the first threshold value for each of a plurality of facilities in the area, according to at least one of whether the facility is located outdoor, whether the facility is a facility in which food and beverage are served, or whether the facility is a facility in which customers have conversations with one another.

### [Supplementary Note 7]

The electronic currency value determination apparatus according to any one of supplementary notes 3 to 6, wherein the value determination means changes the first threshold value for each of a plurality of facilities in the area according to whether a facility existing in the area is a facility in which a measure against infectious disease is taken and/or according to a degree of a measure against infectious disease in a facility existing in the area.

### [Supplementary Note 8]

The electronic currency value determination apparatus according to any one of supplementary notes 2 to 7, wherein, when the congestion degree is lower than a second threshold value, the value determination means increases the money conversion rate to be higher than a money conversion rate in a case in which the congestion degree is higher than the second threshold value.

### [Supplementary Note 9]

The electronic currency value determination apparatus according to any one of supplementary notes 1 to 8, wherein the value determination means further determines, according to whether a facility is a specific facility certified in a region, a utility value of the electronic currency in the specific facility.

### [Supplementary Note 10]

The electronic currency value determination apparatus according to any one of supplementary notes 1 to 9, wherein the value determination means further determines a utility value of the electronic currency in the area according to an attribute of a person who uses the electronic currency.

### [Supplementary Note 11]

An electronic currency system comprising:
an electronic currency value determination apparatus including congestion degree measurement means for measuring a congestion degree in each of a plurality of areas in which an electronic currency issued to a user can be used and value determination means for determining a utility value of the electronic currency in the area, based on a congestion degree measured by the congestion degree measurement means; and
a payment server configured to allow the user to use the electronic currency at a utility value determined by the electronic currency value determination apparatus.

### [Supplementary Note 12]

The electronic currency system according to supplementary note 11, wherein
the electronic currency is issued as a point that can be converted into money, and
the value determination means determines a money conversion rate per unit point as a utility value of the electronic currency.

### [Supplementary Note 13]

The electronic currency system according to supplementary note 12, wherein, when the congestion degree is higher than a first threshold value, the value determination means decreases the money conversion rate to be lower than a money conversion rate in a case in which the congestion degree is lower than the first threshold value.

### [Supplementary Note 14]

An electronic currency value determination method comprising:
measuring a congestion degree in each of a plurality of areas in which an electronic currency issued to a user can be used; and
determining a utility value of the electronic currency in the area, based on the measured congestion degree.

### [Supplementary Note 15]

A non-transitory computer-readable medium storing a program for causing a computer to execute processing of:
measuring a congestion degree in each of a plurality of areas in which an electronic currency issued to a user can be used; and
determining a utility value of the electronic currency in the area, based on the measured congestion degree.

### REFERENCE SIGNS LIST

100 ELECTRONIC CURRENCY SYSTEM
111 CONGESTION DEGREE MEASUREMENT UNIT
112 VALUE DETERMINATION UNIT
113 FACILITY CHARACTERISTIC ACQUISITION UNIT
115 CHARACTERISTIC INFORMATION STORAGE UNIT
120 PAYMENT SERVER
500 COMPUTER APPARATUS
510 CPU
520 STORAGE UNIT
53 ROM
54 RAM
550 COMMUNICATION INTERFACE
560 USER INTERFACE

What is claimed is:

1. An electronic currency value determination apparatus comprising:
a memory storing instructions; and
a processor configured to execute the instructions to:
measure a congestion degree in each of a plurality of areas in which an electronic currency issued to a user can be used; and
determine a utility value of the electronic currency in the area, based on the measured congestion degree.

2. The electronic currency value determination apparatus according to claim 1, wherein
the electronic currency is issued as a point that can be converted into money, and
the processor is configured to execute the instructions to determine a money conversion rate per unit point as a utility value of the electronic currency.

3. The electronic currency value determination apparatus according to claim 2, wherein, when the congestion degree is higher than a first threshold value, the processor is configured to execute the instructions to decrease the money conversion rate to be lower than a money conversion rate in a case in which the congestion degree is lower than the first threshold value.

4. The electronic currency value determination apparatus according to claim 3, wherein the processor is configured to execute the instructions to determine the money conversion rate to be zero when the congestion degree is higher than the first threshold value.

5. The electronic currency value determination apparatus according to claim 3, wherein the processor is configured to execute the instructions to change the first threshold value for each of a plurality of facilities in the area, according to a characteristic of a facility existing in the area.

6. The electronic currency value determination apparatus according to claim 3, wherein the processor is configured to execute the instructions to change the first threshold value for each of a plurality of facilities in the area, according to at least one of whether the facility is located outdoor, whether the facility is a facility in which food and beverage are served, or whether the facility is a facility in which customers have conversations with one another.

7. The electronic currency value determination apparatus according to claim 3, wherein the processor is configured to execute the instructions to change the first threshold value for each of a plurality of facilities in the area according to whether a facility existing in the area is a facility in which a measure against infectious disease is taken and/or according to a degree of a measure against infectious disease in a facility existing in the area.

8. The electronic currency value determination apparatus according to claim 2, wherein, when the congestion degree is lower than a second threshold value, the processor is configured to execute the instructions to increase the money conversion rate to be higher than a money conversion rate in a case in which the congestion degree is higher than the second threshold value.

9. The electronic currency value determination apparatus according to claim 1, wherein the processor is further configured to execute the instructions to determine, according to whether a facility is a specific facility certified in a region, a utility value of the electronic currency in the specific facility.

10. The electronic currency value determination apparatus according to claim 1, wherein the processor is further configured to execute the instructions to determine a utility value of the electronic currency in the area according to an attribute of a person who uses the electronic currency.

11. An electronic currency system comprising:
the electronic currency value determination apparatus according to claim 1; and
a payment server configured to allow the user to use the electronic currency at a utility value determined by the electronic currency value determination apparatus.

12. The electronic currency system according to claim 11, wherein
the electronic currency is issued as a point that can be converted into money, and
the processor is configured to execute the instructions to determine a money conversion rate per unit point as a utility value of the electronic currency.

13. The electronic currency system according to claim 12, wherein, when the congestion degree is higher than a first threshold value, the processor is configured to execute the instructions to decrease the money conversion rate to be lower than a money conversion rate in a case in which the congestion degree is lower than the first threshold value.

14. An electronic currency value determination method comprising:
measuring a congestion degree in each of a plurality of areas in which an electronic currency issued to a user can be used; and
determining a utility value of the electronic currency in the area, based on the measured congestion degree.

15. A non-transitory computer-readable medium storing a program for causing a computer to execute processing of:
measuring a congestion degree in each of a plurality of areas in which an electronic currency issued to a user can be used; and
determining a utility value of the electronic currency in the area, based on the measured congestion degree.
